(19) United States
(12) Patent Application Publication
(10) Pub. No.: US 2026/0363354 A1
(43) Pub. Date: Nov. 19, 2026

(54) TERMINAL DEVICE AND CONTROL METHOD

(71) Applicant: Japan Tobacco Inc., Tokyo (JP)

(72) Inventor: Manabu YAMADA, Tokyo (JP)

(73) Assignee: Japan Tobacco Inc., Tokyo (JP)

(21) Appl. No.: 19/136,445

(22) PCT Filed: Dec. 13, 2022
(86) PCT No.: PCT/JP2022/045794

§ 371 Date: Jun. 6, 2025

(51) Int. Cl. A24F 40/65; A24F 40/20; A24F 40/53; A24F 40/60

(52) U.S. Cl. CPC A24F 40/65; A24F 40/53; A24F 40/60; A24F 40/20

(57) ABSTRACT

A terminal device including a control unit for controlling processing in which an evaluation period, in which a user is able to set a smoking taste evaluation in relation to an aerosol generated by an inhalation device which generates the aerosol by heating an aerosol source contained in a substrate, is set on the basis of a behavior history of the user, and setting of the smoking taste evaluation is received in the evaluation period which has been set.

### TECHNICAL FIELD

The present invention relates to a terminal device and a control method.

### BACKGROUND ART

Inhalation devices that generate substances to be inhaled by a user, such as e-cigarettes and nebulizers, are in widespread use. For example, an inhalation device employs an aerosol source for generating an aerosol, and a substrate including a flavor source or the like for imparting a flavor component to the generated aerosol, to generate an aerosol to which the flavor component has been imparted. The user can enjoy the flavor by inhaling the aerosol to which the flavor component has been imparted, generated by the inhalation device. The action by which the user inhales the aerosol is also referred to below as “puffing” or a “puffing action”.

There is a need to further improve the flavor (also referred to below as the “smoking taste”) which the user enjoys when puffing on the inhalation device. For example, PTL 1 below describes the feature of a substrate capable of improving the smoking taste. PTL 1 below further indicates that the smoking taste is evaluated in several examples of substrates.

### CITATION LIST

### Patent Literature

PTL 1: JP 6839181 B2

### SUMMARY OF INVENTION

### Technical Problem

However, as described in PTL 1 above, the smoking taste evaluation was carried out under a strict environment, such as being conducted by limited evaluators using dedicated equipment in a laboratory.

Accordingly, the present disclosure takes account of the abovementioned problems, and the objective of the present disclosure lies in providing an arrangement that enables a smoking taste evaluation to be performed more easily.

### Solution to Problem

In order to solve the problem above, one aspect of the present invention provides a terminal device comprising a control unit for controlling processing wherein an evaluation period, in which a user is able to set a smoking taste evaluation in relation to an aerosol generated by an inhalation device which generates the aerosol by heating an aerosol source contained in a substrate, is set on the basis of a behavior history of the user, and setting of the smoking taste evaluation is received in the evaluation period which has been set.

The control unit may set a plurality of evaluation periods within a period during which the aerosol is generated by heating one substrate, and the behavior history of the user may include intervals of a plurality of second puff timings, which are timings at which the user actually inhaled the aerosol within a past period in which the aerosol was generated by heating one substrate.

The control unit may set a plurality of evaluation periods within a period during which the aerosol is generated by heating one substrate, and the behavior history of the user may include each of a plurality of second puff timings, which are timings at which the user actually inhaled the aerosol within a past period in which the aerosol was generated by heating one substrate.

The control unit may also set the evaluation period on the basis of the behavior history of another user.

The control unit may control processing to notify the user of information indicating the evaluation period.

The inhalation device may heat the aerosol source on the basis of control information defining a parameter relating to a temperature at which the aerosol source is heated, and the control unit may set the evaluation period on the basis of the control information used by the inhalation device.

The control unit may set the evaluation period on the basis of the substrate used in the inhalation device.

The control unit may terminate acceptance of setting of the smoking taste evaluation in the evaluation period when the smoking taste evaluation has been set or when the evaluation period has expired.

The control unit may control processing to notify the user of the smoking taste evaluation which has been set.

The control unit may set a first puff timing on the basis of the behavior history of the user, the first puff timing being a timing at which the user should inhale the aerosol generated by the inhalation device, and the control unit may set the evaluation period on the basis of the first puff timing which has been set.

The behavior history of the user may include information indicating a second puff timing, which is a timing at which the user actually inhaled the aerosol within a past period in which the aerosol was generated by heating one substrate, and the control unit may set, as the first puff timing, a timing which is the same as the second puff timing.

The behavior history of the user may include information indicating a second puff timing, which is a timing at which the user actually inhaled the aerosol within a past period in which the aerosol was generated by heating one substrate, and the control unit may set, as the first puff timing, a timing which is different from the second puff timing.

Furthermore, in order to solve the problem above, another aspect of the present invention provides a control method implemented by means of a computer, the control method comprising: controlling processing wherein an evaluation period, in which a user is able to set a smoking taste evaluation in relation to an aerosol generated by an inhalation device which generates the aerosol by heating an aerosol source contained in a substrate, is set on the basis of a behavior history of the user, and setting of the smoking taste evaluation is received in the evaluation period which has been set.

### Advantageous Effects of Invention

The present invention as described above provides an arrangement that enables a smoking taste evaluation to be performed more easily.

### BRIEF DESCRIPTION OF DRAWINGS

FIG. 1 is a diagram to illustrate a configuration example of a system according to an embodiment.

FIG. 2 is a schematic diagram illustrating schematically a configuration example of an inhalation device.

FIG. 3 is a block diagram showing a configuration example of a terminal device according to the embodiment.

FIG. 4 is a graph schematically showing an example of a heating profile.

FIG. 5 is a diagram showing an example of a UI screen displayed by the terminal device according to the embodiment.

FIG. 6 is a sequence chart showing an example of a processing flow implemented by the system according to the embodiment.

### DESCRIPTION OF EMBODIMENTS

Preferred embodiments of the present invention will be described in detail below with reference to the appended drawings. It should be noted that in the specification and the drawings, duplicate descriptions are omitted by using the same reference signs to denote constituent elements having substantially the same functional configuration.

### 1. Configuration Example

### (1) System Configuration Example

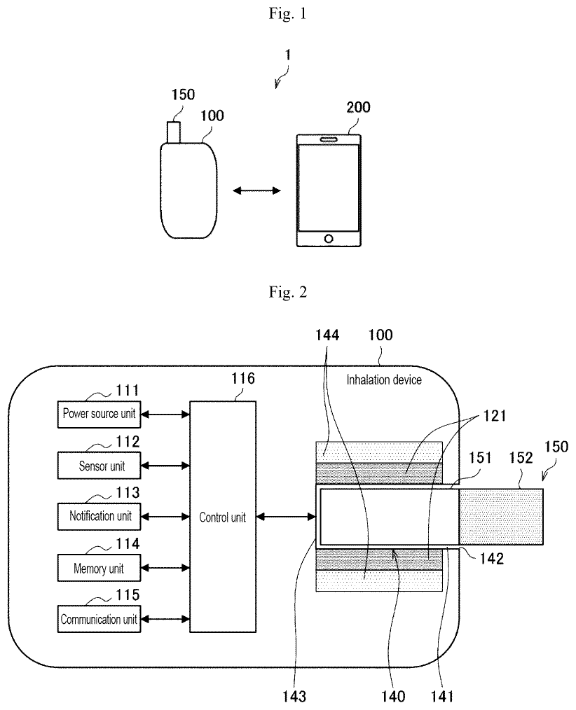

FIG. 1 is a diagram to illustrate a configuration example of a system 1 according to an embodiment. As shown in FIG. 1, the system 1 includes an inhalation device 100 and a terminal device 200.

The inhalation device 100 is a device for generating a substance to be inhaled by a user. Hereinafter, the substance generated by the inhalation device 100 will be described as being an aerosol. Alternatively, the substance generated by the inhalation device 100 may be a gas. The inhalation device 100 generates the aerosol by using a stick-type substrate 150. The stick-type substrate 150 is an example of a substrate that contains an aerosol source. The inhalation device 100 is an example of an aerosol-generating device for generating an aerosol by heating the aerosol source contained in the substrate.

The terminal device 200 is an information processor for performing various types of information processing relating to the inhalation device 100. The terminal device 200 is used by a user of the inhalation device 100. The terminal device 200 may be any device such as a smartphone, a tablet terminal, a wearable device, or a personal computer (PC). Alternatively, the terminal device 200 may be a charger that charges the inhalation device 100.

The terminal device 200 performs processing to assist a user in using the inhalation device 100. As an example, the terminal device 200 notifies the user of the appropriate method of using the inhalation device 100. As another example, the terminal device 200 receives a user operation for changing settings of the inhalation device 100, and changes the settings of the inhalation device 100. As another example, the terminal device 200 collects an operation log of the inhalation device 100 and reports the operation log to a server.

### (2) Configuration Example of Inhalation Device 100

FIG. 2 is a schematic diagram illustrating schematically a configuration example of the inhalation device 100. As illustrated in FIG. 2, the inhalation device 100 according to this configuration example comprises: a power source unit 111, a sensor unit 112, a notification unit 113, a memory unit 114, a communication unit 115, a control unit 116, a heating unit 121, an accommodating portion 140, and a heat insulating portion 144.

The power source unit 111 stores electrical power. The power source unit 111 then supplies the electrical power to each component of the inhalation device 100 in accordance with control performed by the control unit 116. The power source unit 111 may be configured, for example, by a rechargeable battery such as a lithium ion secondary battery.

The sensor unit 112 acquires various types of information relating to the inhalation device 100. As an example, the sensor unit 112 is configured by a pressure sensor such as a condenser microphone, a flow rate sensor or a temperature sensor, etc., and acquires values associated with inhalation by a user. As another example, the sensor unit 112 is configured by an input device, such as a button or switch, for accepting input of information from the user.

The notification unit 113 notifies the user of the information. The notification unit 113 is configured by a light-emitting device which emits light, a display device which displays images, a sound output device which outputs sound, or a vibration device which vibrates, etc., for example.

The memory unit 114 stores various types of information for the operation of the inhalation device 100. The memory unit 114 is configured by a non-volatile storage medium such as a flash memory, for example.

The communication unit 115 is a communication interface capable of performing communication conforming to any wired or wireless communication standard. Examples of communication standards that may be used include standards that employ Wi-Fi (registered trademark), Bluetooth (registered trademark), BLE (Bluetooth Low Energy) (registered trademark), NFC (Near-Field Communication), or LPWA (Low Power Wide Area), for example.

The control unit 116 functions as an arithmetic processing device and a control device, and controls overall operation within the inhalation device 100 in accordance with various programs. The control unit 116 is realized by a CPU (Central Processing Unit) or an electronic circuit such as a microprocessor, for example.

The accommodating portion 140 has an internal space 141, and holds a stick-type substrate 150 while accommodating a portion of the stick-type substrate 150 in the internal space 141. The accommodating portion 140 has an opening 142 allowing the internal space 141 to communicate with the outside, and accommodates the stick-type substrate 150 that has been inserted into the internal space 141 from the opening 142. For example, the accommodating portion 140 is a cylindrical body comprising the opening 142 and a bottom portion 143 serving as a bottom surface, and defines a columnar internal space 141. An air flow path for supplying air to the internal space 141 is connected to the accommodating portion 140. An air inflow hole, which is an inlet for air into the air flow path, is disposed in a side surface of the inhalation device 100, for example. An air outflow hole serving as an outlet for air from the air flow path to the internal space 141 is disposed in the bottom portion 143, for example.

The stick-type substrate 150 comprises a substrate portion 151 and a mouthpiece portion 152. The substrate portion 151 includes an aerosol source. The aerosol source includes a tobacco-derived or non-tobacco-derived flavor component. If the inhalation device 100 is a medical inhaler such as a nebulizer, the aerosol source may include a drug. The aerosol source may, for example, be a liquid such as water or a polyhydric alcohol, for example glycerol or propylene glycol, containing the tobacco-derived or non-tobacco-derived flavor component, or may be a solid including the tobacco-derived or non-tobacco-derived flavor component. In a state in which the stick-type substrate 150 is being held in the accommodating portion 140, at least a portion of the substrate portion 151 is accommodated in the internal space 141, and at least a portion of the mouthpiece portion 152 protrudes from the opening 142. Then, when the user holds the mouthpiece portion 152 protruding from the opening 142 in their mouth and inhales, air flows into the internal space 141 via the air flow path, which is not illustrated in the drawings, and reaches the inside of the user's mouth together with the aerosol generated from the substrate portion 151.

The heating unit 121 heats the aerosol source to atomize the aerosol source, thereby generating the aerosol. In the example shown in FIG. 2, the heating unit 121 has a film-like form and is arranged so as to cover the outer circumference of the accommodating portion 140. Then, when the heating unit 121 generates heat, the substrate portion 151 of the stick-type substrate 150 is heated from the outer circumference and an aerosol is generated. The heating unit 121 generates heat when supplied with electricity from the power source unit 111. By way of example, electricity may be supplied when the sensor unit 112 detects that the user has started inhaling and/or that predetermined information has been input. The supply of electricity may then be stopped when the sensor unit 112 detects that the user has finished inhaling and/or that predetermined information has been input.

The heat insulating portion 144 prevents heat transfer from the heating unit 121 to other components. For example, the heat insulating portion 144 is configured from a vacuum heat insulating material or an aerogel heat insulating material, or the like.

A configuration example of the inhalation device 100 has been described above. The inhalation device 100 is, of course, not limited to the configuration described above, and may adopt various configurations, such as those illustrated below by way of example.

As one example, the heating unit 121 may have a blade-like form and may be arranged so as to protrude into the internal space 141 from the bottom portion 143 of the accommodating portion 140. In that case, the blade-like heating unit 121 is inserted into the substrate portion 151 of the stick-type substrate 150 and heats the substrate portion 151 of the stick-type substrate 150 from the inside. As another example, the heating unit 121 may be arranged so as to cover the bottom portion 143 of the accommodating portion 140. Furthermore, the heating unit 121 may be configured by a combination of two or more from among a first heating unit covering the outer circumference of the accommodating portion 140, a blade-like second heating unit, and a third heating unit covering the bottom portion 143 of the accommodating portion 140.

As another example, the accommodating portion 140 may comprise an opening/closing mechanism such as a hinge for opening/closing part of a casing that forms the internal space 141. By opening/closing the casing, the accommodating portion 140 may then receive and grip the stick-type substrate 150 which has been inserted into the internal space 141. In that case, the heating unit 121 may be provided on the part of the accommodating portion 140 gripping the stick-type substrate 150, and may heat the stick-type substrate 150 while pressing same.

Furthermore, the means for atomizing the aerosol source is not limited to heating provided by the heating unit 121. For example, the means for atomizing the aerosol source may be induction heating. In that case, the inhalation device 100 comprises at least an electromagnetic induction source such as a coil for generating a magnetic field, instead of the heating unit 121. A susceptor which generates heat by means of induction heating may be provided in the inhalation device 100, or may be contained in the stick-type substrate 150.

It should be noted that the inhalation device 100 collaborates with the stick-type substrate 150 to generate an aerosol to be inhaled by the user. As such, the combination of the inhalation device 100 and the stick-type substrate 150 may be considered as an aerosol-generating system.

### (3) Configuration Example of Terminal Device

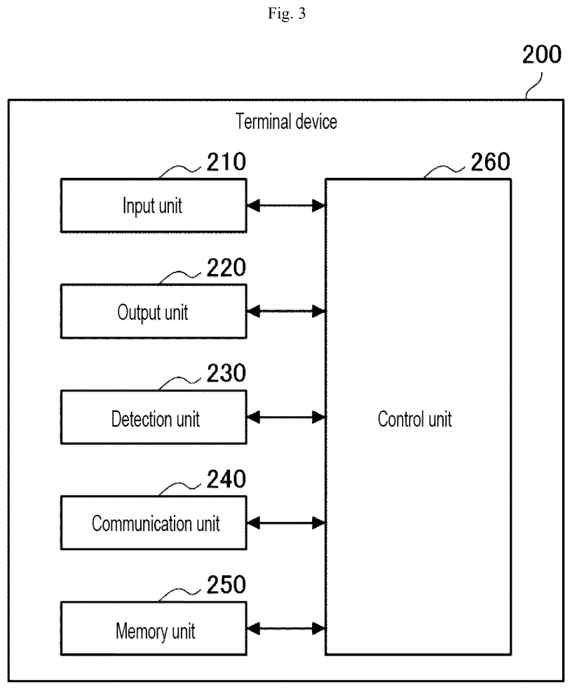

FIG. 3 is a block diagram showing a configuration example of the terminal device 200 according to the embodiment. As shown in FIG. 3, the terminal device 200 includes an input unit 210, an output unit 220, a detection unit 230, a communication unit 240, a memory unit 250, and a control unit 260.

The input unit 210 has the function of receiving input of various types of information. The input unit 210 may include an input device that receives input of information from the user. Examples of input devices that may be cited include a button, a keyboard, a touch panel, and a microphone, etc. Alternatively, the input unit 210 may include various types of sensors such as an image sensor.

The output unit 220 has the function of outputting information. The output unit 220 may include an output device that outputs information to the user. Examples of output devices that may be cited include: a display device for displaying information, a light-emitting device for emitting light, a vibration device which vibrates, and a sound output device for outputting sound, etc. A display is an example of the display device. A light-emitting diode (LED) is an example of the light-emitting device. An eccentric motor is an example of the vibration device. A speaker is an example of the sound output device. The output unit 220 outputs the information input from the control unit 260 to notify the user of the information.

The detection unit 230 has the function of detecting information relating to the terminal device 200. The detection unit 230 may detect location information of the terminal device 200. For example, the detection unit 230 receives a GNSS (global navigation satellite system) signal from a GNSS satellite (e.g., a GPS signal from a GPS (global positioning system) satellite), and detects location information comprising the longitude and latitude of the device. The detection unit 230 may detect movement of the terminal device 200. For example, the detection unit 230 includes a gyro sensor and an acceleration sensor, and detects an angular velocity and an acceleration.

The communication unit 240 is a communication interface for sending and receiving information between the terminal device 200 and another device. The communication unit 240 performs communication conforming to any wired or wireless communication standard. Examples of communication standards which may be used include standards employing USB (universal serial bus), Wi-Fi (registered trademark), Bluetooth (registered trademark), NFC (near field communication), or LPWA (low-power wide area), etc.

The memory unit 250 stores various types of information. The memory unit 250 is configured by a non-volatile storage medium such as a flash memory, for example.

The control unit 260 functions as an arithmetic processing device or a control device, controlling overall operation within the terminal device 200 in accordance with various programs. The control unit 260 is realized by a CPU (central processing unit) or an electronic circuit such as a microprocessor, for example. The control unit 260 may also include a ROM (read-only memory) for storing programs and computation parameters, etc. which are used, and a RAM (random access memory) for temporarily storing suitably changing parameters, etc. The terminal device 200 implements various types of processing based on control performed by the control unit 260. Examples of processing controlled by the control unit 260 include: processing of information input by means of the input unit 210, output of information by the output unit 220, detection of information by the detection unit 230, sending and receiving of information by the communication unit 240, and storage/reading of information by the memory unit 250. Other processing implemented by the terminal device 200, such as processing based on input of information to each component and information output from each component, are also controlled by means of the control unit 260.

It should be noted that the functions of the control unit 260 may be realized using an application. The application may be pre-installed or downloaded. Furthermore, the functions of the control unit 260 may be realized by means of PWA (progressive web apps).

### 2. Technical Features

### (1) Heating Profile

The control unit 116 controls the operation of the heating unit 121 based on the heating profile. Control of the operation of the heating unit 121 is achieved by controlling the supply of power from the power source unit 111 to the heating unit 121. The heating unit 121 heats the stick-type substrate 150 using power supplied from the power source unit 111.

The heating profile is control information for controlling the temperature at which the aerosol source is heated. The heating profile defines a parameter relating to a temperature at which the aerosol source is heated. The temperature of the heating unit 121 is an example of the temperature at which the aerosol source is heated. A target value of the temperature of the heating unit 121 (also referred to below as the “target temperature”) is an example of a parameter relating to the temperature at which the aerosol source is heated. The temperature of the heating unit 121 may be controlled to change in accordance with the time elapsed from the start of heating. In this case, the heating profile includes information defining a time-series transition of the target temperature. As another example, the heating profile may comprise a parameter (hereinafter also referred to as a power supply parameter) defining how power is supplied to the heating unit 121. Power supply parameters include, for example, a voltage applied to the heating unit 121, ON/OFF of the power supply to the heating unit 121, or a method of feedback control to be employed. ON/OFF of the power supply to the heating unit 121 may be considered as ON/OFF of the heating unit 121.

The control unit 116 controls the operation of the heating unit 121 such that the temperature of the heating unit 121 (also referred to below as the “actual temperature”) transitions similarly to the target temperature defined in the heating profile. The heating profile is typically designed such that, when the user inhales the aerosol generated from the stick-type substrate 150, the flavour tasted by the user is optimized. Thus, by controlling the operation of the heating unit 121 based on the heating profile, the flavor tasted by the user can be optimized.

The temperature control of the heating unit 121 can be achieved by known feedback control, for example. The feedback control may be a Proportional-Integral-Differential Controller (PID) control, for example. The control unit 116 may cause power from the power supply unit 111 to be supplied to the heating unit 121 in the form of pulses by pulse width modulation (PWM) or pulse frequency modulation (PFM). In that case, the control unit 116 can perform temperature control of the heating unit 121 by adjusting the frequency or the duty ratio of the power pulse in feedback control. Alternatively, the control unit 116 may perform simple ON/OFF control in feedback control. For example, the control unit 116 may perform heating by the heating unit 121 until the actual temperature reaches the target temperature, interrupt heating by the heating unit 121 when the actual temperature reaches the target temperature, and resume heating by the heating unit 121 when the actual temperature falls below the target temperature.

The temperature of the heating unit 121 can be quantified by measuring or estimating the electrical resistance value of the heating unit 121 (a heating resistive element constituting the heating unit 121, to be more precise), for example. This is because the electrical resistance value of the heating resistive element varies with temperature. The electrical resistance value of the heating resistive element can be estimated by measuring the amount of voltage drop at the heating resistive element, for example. The amount of voltage drop at the heating resistive element can be measured by a voltage sensor measuring a potential difference applied to the heating resistive element. In another example, the temperature of the heating unit 121 can be measured by a temperature sensor such as a thermistor installed near the heating unit 121.

The period from the start of the process of generating an aerosol using the stick-type substrate 150 to the end is also referred to hereinafter as a heating session. In other words, a heating session is a period of time during which electrical supply to the heating unit 121 is controlled on the basis of the heating profile. The beginning of the heating session is the timing at which heating based on the heating profile is started. The end of the heating session is the timing at which a sufficient amount of aerosol is no longer generated. The heating session comprises a first-half preheating period and a second-half puffing-enabled period. The puffing-enabled period is the period of time during which a sufficient amount of aerosol is expected to be generated. The preheating period is the period from when heating is started until the puffing-enabled period is started. Heating performed in the preheating period is also referred to as preheating.

The notification unit 113 may notify the user of information indicative of the timing at which the preheating ends. For example, the notification unit 113 notifies the user of information announcing the end of the preheating period before the preheating period ends, or notifies the user of information indicating that the preheating has ended at the timing at which the preheating has ended. The notification to the user can be by lighting an LED or vibrating, or the like, for example. By referring to such notification, the user is able to take a puff immediately after the end of the preheating.

Similarly, the notification unit 113 may notify the user of information indicative of when the puffing-enabled period ends. For example, the notification unit 113 notifies the user of information announcing the end of the puffing-enabled period before the puffing-enabled period ends, or notifies the user of information indicating that the puffing-enabled period has ended at the timing at which the puffing-enabled period has ended. The notification to the user may be issued by lighting an LED or by means of vibrations, for example. By referring to such notification, the user is able to take puffs until the end of the puffing-enabled period.

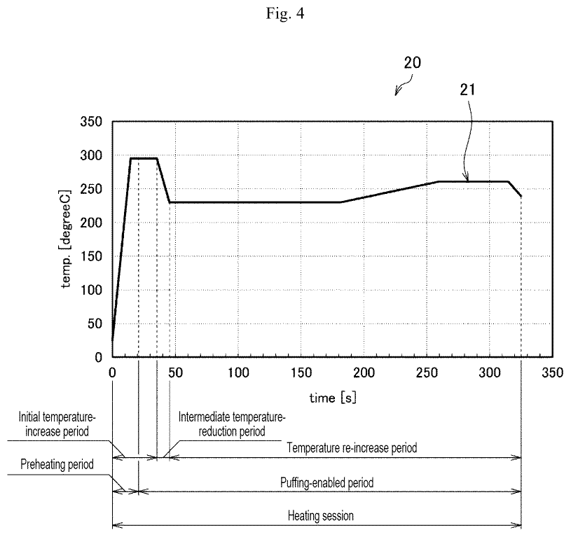

An example of the heating profile will be described with reference to FIG. 4. FIG. 4 is a graph schematically showing an example of a heating profile. The horizontal axis of the graph 20 denotes time. The vertical axis of the graph 20 denotes temperature. The line 21 denotes a time-series transition of the target temperature. As shown in FIG. 4, the heating session may include an initial temperature-increase period, an intermediate temperature-reduction period, and a temperature re-increase period in succession. The initial temperature-increase period is a period in which the temperature of the heating unit 121 rapidly rises after the start of heating and is kept at a high temperature. The intermediate temperature-reduction period is a period in which the temperature of the heating unit 121 drops after the initial temperature-increase period. The temperature re-increase period is a period in which the temperature of the heating unit 121 is once again increased after the intermediate temperature-reduction period. In the example shown in FIG. 4, the target temperature rapidly increases to around 300 °C during the initial temperature-increase period, then drops to around 230 °C during the intermediate temperature-reduction period, after which the temperature increases stepwise to around 260 °C during the temperature re-increase period. During the intermediate temperature-reduction period, electrical supply to the heating unit 121 may be interrupted and heating may be turned OFF. In the example shown in FIG. 4, the period from the start of heating to partway through the initial temperature-increase period is the preheating period, and the period from part way through the initial temperature-increase period to the end of the temperature re-increase period is the puffing-enabled period.

### (2) Setting of Smoking Taste Evaluation

The terminal device 200 prompts the user to puff at a suitable timing and receives a smoking taste evaluation for the aerosol inhaled. The terminal device 200 then stores information indicating the evaluation received (also referred to below as the “evaluation result”), and appropriately sends this to a server which collects evaluation results. Note that, in the present description, timing refers to the time elapsed from the start of heating of one stick-type substrate 150 based on the heating profile.

The server collects and stores evaluation results from a plurality of terminal devices 200 operated by a plurality of users, and uses the evaluation results for various purposes. For example, the server first of all aggregates the evaluation results. As an example of a method for aggregating the evaluation results which may be cited, evaluations of the X-th puff taken during heating sessions are averaged over a plurality of evaluation results, and this is performed for all puffs. The server then updates the heating profile to further improve the evaluation. In this way, the terminal device 200 prompts the user to puff and receives a smoking taste evaluation, which is expected to improve the quality of the subsequent user experience as a result.

The terminal device 200 performs various types of processing in order to receive a smoking taste evaluation, which contributes to improving the quality of a user experience. This will be described in detail below.

### Setting and Notification of First Puff Timing

The terminal device 200 (e.g., the control unit 260) sets a first puff timing. The first puff timing is a timing at which the user should inhale the aerosol generated by the inhalation device 100. In particular, the terminal device 200 sets the first puff timing on the basis of a behavior history of the user. The terminal device 200 then controls processing to notify the user of information indicating the first puff timing which has been set. By virtue of this feature, the user can take a puff at a suitable timing deduced from the behavior history of the user himself or herself. Furthermore, if the user takes a puff at the first puff timing which was notified, this allows the evaluation results to be collected with simpler aggregation in the server, as compared to when the user takes puffs at any timing.

The terminal device 200 sets a plurality of first puff timings within the period in which an aerosol is generated by heating one stick-type substrate 150, i.e., within a heating session. In particular, the terminal device 200 sets a plurality of first puff timings within a puffing-enabled period. This allows the user to take puffs at multiple suitable timings within one heating session.

The behavior history of the user includes information indicating a second puff timing. The second puff timing is the timing at which the user actually took puffs within a past heating session. The terminal device 200 may set, as the first puff timing, a timing which is the same as the second puff timing. For example, the terminal device 200 may set, as the first puff timing, the same timing as the second puff timing or a timing shifted by around several seconds. By virtue of this feature, the user can evaluate the smoking taste while taking puffs at the same timing as usual. That is, the user can set the smoking taste evaluation without changing their normal behavior. The burden on the user can therefore be lightened.

As an example, the user behavior history may include intervals between a plurality of second puff timings in a past heating session. For example, if the user took puffs at an average of 20-second intervals in a plurality of past heating sessions, the terminal device 200 sets the first puff timing at 20-second intervals in the next heating session. By virtue of this feature, the user can take puffs at the same timing as usual.

As another example, the user behavior history may include each of a plurality of second puff timings in past heating sessions. For example, the terminal device 200 may set the average value of initial second puff timings (i.e., the time elapsed from the start of heating) in a plurality of past heating sessions as the initial first puff timing in the next heating session. By virtue of this feature, the user can take puffs at the same timing as usual.

The terminal device 200 may also set the first puff timing on the basis of the behavior history of other users. That is, the terminal device 200 may set the first puff timing based on the behavior history of a plurality of users. For example, the terminal device 200 may set, as the first puff timing, the average value of second puff timings of a plurality of users. By virtue of this feature, the user can take puffs at the same timing as many other users. Furthermore, it is easy to aggregate the evaluation results collected from a plurality of users.

The terminal device 200 determines that the set first puff timing has been reached. For example, the inhalation device 100 may send information indicating the start of heating to the terminal device 200 at the start of heating based on the heating profile. In this case, receipt of such information triggers a count by the terminal device 200 of the time elapsed from the start of heating, and the terminal device 200 determines that the first puff timing has been reached The terminal device 200 then controls processing to notify the information indicating the first puff timing which has been set.

As an example, the terminal device 200 may notify information indicating the first puff timing which has been set. Specifically, the terminal device 200 may output, to a display, an image displaying information indicating that the first puff timing will be reached in a few seconds or has already been reached, or the terminal device 200 may vibrate at the first puff timing. By virtue of this feature, the user can easily ascertain the first puff timing.

As another example, the terminal device 200 may control the inhalation device 100 to notify information indicating the first puff timing which has been set. Specifically, the terminal device 200 may control the inhalation device 100 so that the LED emits light or so that vibration is produced at the first puff timing. For example, each time a first puff timing is reached, the terminal device 200 transmits to the inhalation device 100 information instructing that the user be notified. In this case, the inhalation device 100 causes the LED to emit light or vibrates each time such information is received. By virtue of this feature, the user can easily ascertain the first puff timing even in a situation where the user is using the inhalation device 100 while the terminal device 200 remains inside a bag, for example.

### Setting and Notification of Evaluation Period

Based on the first puff timing, the terminal device 200 sets an evaluation period in which the user is able to set a smoking taste evaluation in relation to the aerosol inhaled at the first puff timing. The terminal device 200 then controls processing to receive setting of the smoking taste evaluation in the evaluation period which has been set. For example, the terminal device 200 displays, on a touch panel, a UI (user interface) screen for setting the smoking taste evaluation, and receives a touch operation for setting the smoking taste evaluation during the evaluation period. By virtue of this feature, a user can evaluate the smoking taste while using the inhalation device 100. Since it is not necessary to use a dedicated device to evaluate the smoking taste, the smoking taste evaluation can be performed more easily. It is also possible to collect smoking taste evaluations from a broad range of typical users.

The terminal device 200 sets a plurality of evaluation periods within the heating session. In particular, the terminal device 200 sets one evaluation period for one first puff timing. For example, the terminal device 200 sets, as the evaluation period, a predetermined period including the first puff timing or a predetermined period following the first puff timing. By virtue of this feature, the user can set a smoking taste evaluation for each puff immediately after the relevant puff in response to the notification of the first puff timing. Accordingly, the user can set a smoking taste evaluation for each puff while it is still fresh in the mind. It is also possible to reduce the burden on the user as compared to when a smoking taste evaluation is set after the heating session has terminated.

Here, the relationship between the first puff timing and the evaluation period may be fixed. For example, the beginning of the evaluation period may be the first puff timing and the end of the evaluation period may be 10 seconds after the first puff timing. In this case, setting the first puff timing may be understood as being synonymous with setting the evaluation period. It may also be understood that notification of the first puff timing is synonymous with notification of the evaluation period. That is, it may be understood that the terminal device 200 sets an evaluation period on the basis of the behavior history of the user and controls processing to notify the user of information indicating the evaluation period.

The terminal device 200 terminates acceptance of setting of the smoking taste evaluation in the evaluation period when the smoking taste evaluation has been set or when the evaluation period has expired. By virtue of this feature, it is possible to prevent a smoking taste evaluation which was set at one time from being accidentally changed, or to prevent an erroneous evaluation from being set on the basis of an unintended operation outside the evaluation period.

### (3) UI Screen

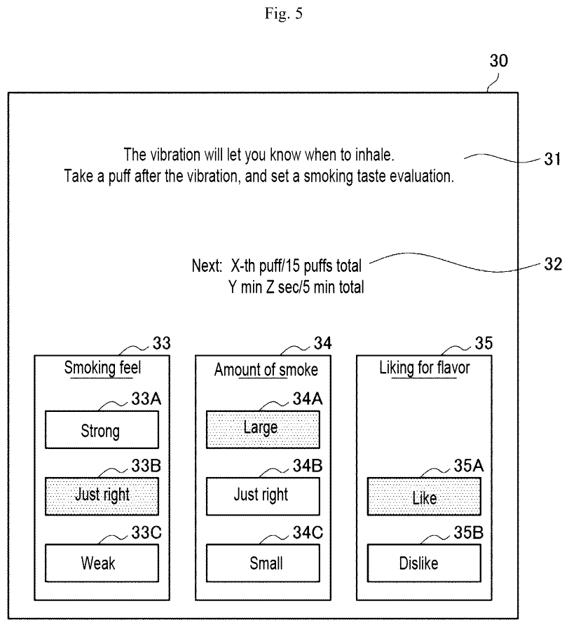

An example of the UI screen displayed by the terminal device 200 will be described with reference to FIG. 5.

FIG. 5 is a diagram showing an example of a UI screen displayed by the terminal device 200 according to the embodiment. The terminal device 200 receives setting of the smoking taste evaluation on an evaluation setting screen 30. As shown in FIG. 5, the evaluation setting screen 30 includes an evaluation method explanation column 31, a progress display column 32, and evaluation setting columns 33-35.

The evaluation method explanation column 31 is a column for notifying the user of the evaluation method. The evaluation method explanation column 31 indicates that the terminal device 200 will vibrate when the timing at which the aerosol should be inhaled has been reached, i.e., that the first puff timing has been reached. The user, referring to this explanation, may take a puff at the timing at which the vibration device 200 vibrates and set a smoking taste evaluation.

The progress display column 32 is a column for notifying the user of information indicating the progress in the process of aerosol generation by the inhalation device 100. More specifically, the progress display column 32 is a column for notifying the user of information indicating the first puff timing and information indicating the evaluation period. The progress of the heating session is displayed in the top part of the progress display column 32, with the numerator being a number indicating which first puff timing will come next, and the denominator being the total number of first puff timings which have been set. The progress of the heating session is displayed in the bottom part of the progress display column 32, with the numerator being the time elapsed from the start of heating, and the denominator being the duration of the heating session. In the example shown in FIG. 5, the display of the progress display column 32 shows that that the X-th first puff timing will come next out of a total of 15 first puff timings, and that a 5-minute heating session has progressed up to Y minutes and Z seconds. By referring to this display, the user can ascertain that the first puff timing has been reached and that the evaluation period has been reached, while also being aware of progress of the heating session.

The evaluation setting columns 33-35 are columns for receiving smoking taste evaluation settings by the user. The evaluation setting column 33 is a column for receiving settings for an evaluation in regard to smoking feel. The evaluation setting column 34 is a column for receiving settings for an evaluation in regard to the amount of smoke. The evaluation setting column 35 is a column for receiving settings for an evaluation in regard to liking for the flavor.

The evaluation setting column 33 for smoking feel includes buttons 33A-33C constituting UI elements for setting the evaluation in regard to smoking feel. The terminal device 200 receives: an evaluation setting that the smoking feel is strong when the button 33A is selected, an evaluation setting that the smoking feel is “just right” when the button 33B is selected, and an evaluation setting that the smoking feel is weak when the button 33C is selected.

The evaluation setting column 34 for amount of smoke includes buttons 34A-34C constituting UI elements for setting the evaluation in regard to the amount of smoke. The terminal device 200 receives: an evaluation setting that the amount of smoke is large when the button 34A is selected, an evaluation setting that the amount of smoke is “just right” when the button 34B is selected, and an evaluation setting that the amount of smoke is small when the button 34C is selected.

The evaluation setting column 35 for liking for the flavor includes buttons 35A and 35B constituting UI elements for setting the evaluation in regard to liking for the flavor. The terminal device 200 receives: an evaluation setting that the user likes the flavor when the button 35A is selected, and an evaluation setting that the user dislikes the flavor when the button 35B is selected.

The terminal device 200 receives settings for the smoking taste evaluation for a plurality of evaluation items in one evaluation period. For example, the terminal device 200 receives, each time a first puff timing is reached, evaluation settings for smoking feel, amount of smoke and liking for the flavor in the evaluation period set in accordance with the first puff timing which has been reached. In the example shown in FIG. 5, buttons 33B, 34A and 35A are respectively selected as smoking taste evaluations at the X-th first puff timing. That is, the user sets an evaluation that the smoking feel is “just right”, the amount of smoke is large, and the user likes the flavor. By virtue of this feature, the user can set smoking taste evaluations from a number of perspectives.

The terminal device 200 notifies the user of information indicating the smoking taste evaluation which has been set. In the example shown in FIG. 5, the terminal device 200 displays the buttons 33B, 34A, and 35A selected by the user in a different form to the other buttons. As an example, the terminal device 200 may display the buttons selected by the user in a different color from other buttons. By virtue of this feature, the user can check the smoking taste evaluation which he or she has set.

An example of the UI screen displayed on the terminal device 200 was described above.

### (4) Processing Flow

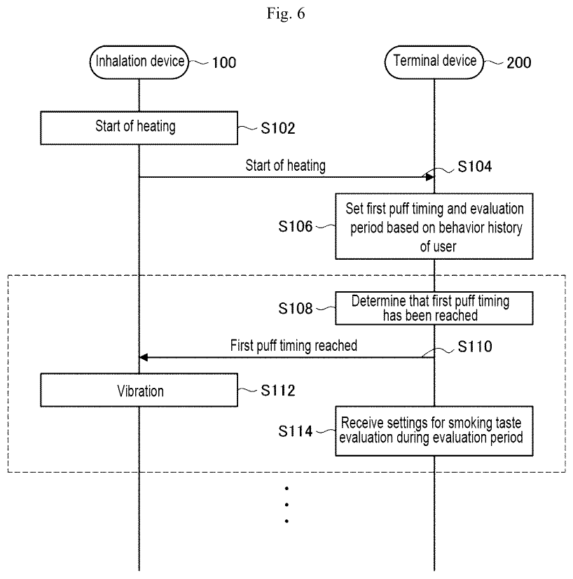

FIG. 6 is a sequence chart showing an example of a processing flow implemented by the system 1 according to the embodiment. As shown in FIG. 6, the inhalation device 100 and the terminal device 200 are involved in the main sequence.

The inhalation device 100 first of all starts heating based on the heating profile (step S102).

The inhalation device 100 then sends information indicating the start of heating to the terminal device 200 (step S104).

Next, the terminal device 200 sets the first puff timing and the evaluation period on the basis of the behavior history of the user (step S106). For example, the terminal device 200 sets, as the first puff timing, a timing which is the same as the second puff timing indicated by the behavior history of the user. The terminal device 210 sets, as the evaluation period, a period of predetermined duration starting from the first puff timing. Here, the terminal device 200 sets a plurality of first puff timings and a plurality of evaluation periods during the heating session.

Next, the terminal device 200 determines that the first puff timing has been reached (step S108). For example, the terminal device 200 determines that the first puff timing has been reached, based on the time elapsed from the start of heating.

The terminal device 200 sends information indicating that the first puff timing has been reached to the inhalation device 100 when it is determined that the first puff timing has been reached (step S110).

The inhalation device 100 vibrates upon receiving information indicating that the first puff timing has been reached (step S112).

Meanwhile, the terminal device 200 receives settings for the smoking taste evaluation during the evaluation period (step S114). When the user senses the vibration in step S112, the user takes a puff and sets the smoking taste evaluation.

The processing according to steps S108-S114 is repeatedly performed in relation to a plurality of first puff timings and a plurality of evaluation periods set in the heating session.

### 3. Supplement

Preferred embodiments of the present invention were described in detail above with reference to the appended drawings, but the present invention is not limited to those examples. It is obvious that a person having ordinary knowledge in the technical field to which the present invention belongs will be able to conceive of a number of variant examples or modified examples within the scope of the technical concept disclosed in the claims, and any such variant examples or modified examples are naturally understood to fall within the technical scope of the present invention.

### (1) First Variant Example

Although the embodiments above described an example in which the terminal device 200 determines that the first puff timing has been reached, the present disclosure is not limited to such an example. The inhalation device 100 may equally determine that the first puff timing has been reached. For example, the terminal device 200 compiles information indicating each of a plurality of first puff timings which have been set (i.e., the time elapsed from the start of heating), and sends the compiled information to the inhalation device 100. The inhalation device 100 then determines that a first puff timing has been reached, based on the information indicating each of the plurality of first puff timings, and gives notification to the user. By virtue of this feature, even if it becomes difficult for the system to operate under real time control by the terminal device 200, such as when communication between the inhalation device 100 and the terminal device 200 is interrupted, the user can still be notified of the information indicating the first puff timing by the inhalation device 100 alone.

### (2) Second Variant Example

The terminal device 200 may set the first puff timing based on the heating profile used by the inhalation device 100. As an example, the inhalation device 100 sends, to the terminal device 200, identification information indicating the heating profile to be used, along with information indicating the start of heating. The terminal device 200 then sets the first puff timing on the basis of the behavior history of the user corresponding to the identification information. Specifically, the terminal device 200 may set the first puff timing based on the behavior history of the user which was acquired when the same heating profile as the heating profile being used by the inhalation device 100 was used. By virtue of this feature, it is possible to set an appropriate first puff timing commensurate with the behavior history of the user, which may vary according to the heating profile being used. Furthermore, the duration of the heating session and the duration from the start of heating to the start of the puffing-enabled period may vary for each heating profile. By virtue of this feature, the first puff timing can thus be appropriately set.

The terminal device 200 may send, to the inhalation device 100, information indicating first puff timings which were set on the basis of a heating profile that may be used by the inhalation device 100, this information being sent in association with the relevant heating profile. As an example, the terminal device 200 reports, to the inhalation device 100, information indicating each of a plurality of first puff timings (i.e., time elapsed from the start of heating) which were set on the basis of a heating profile that may be used by the inhalation device 100, this information being reported along with identification information of the relevant heating profile. The inhalation device 100 then determines that a first puff timing has been reached, based on the information indicating each of the plurality of first puff timings, which is associated with the identification information of the heating profile being used, and gives notification to the user. By virtue of this feature, the inhalation device 100 alone is capable of determining that the first puff timing has been reached, even if there are multiple heating profiles that may be used by the inhalation device 100.

### (3) Third Variant Example

The terminal device 200 may set the first puff timing on the basis of the stick-type substrate 150 used in the inhalation device 100. As an example, the terminal device 200 may set the first puff timing based on the behavior history of the user which was acquired when a stick-type substrate 150 of the same type as the stick-type substrate 150 being used in the inhalation device 100 was used. It should be noted that the type of stick-type substrate 150 used in the inhalation device 100 is determined on the basis of identification information such as a two-dimensional code which is attached to the stick-type substrate 150, and the type of stick-type substrate 150 which is being used may be reported to the terminal device 200 along with information indicating the start of heating. By virtue of this feature, it is possible to set an appropriate first puff timing commensurate with the behavior history of the user, which may vary according to the stick-type substrate 150 being used.

The terminal device 200 may send, to the inhalation device 100, information indicating first puff timings which were set on the basis of a stick-type substrate 150 that may be used in the inhalation device 100, this information being sent in association with the relevant stick-type substrate 150. As an example, the terminal device 200 sends, to the inhalation device 100, information indicating each of a plurality of first puff timings (i.e., time elapsed from the start of heating) which were set on the basis of a stick-type substrate 150 that may be used in the inhalation device 100, this information being sent along with information indicating the type of the relevant stick-type substrate 150. The inhalation device 100 then identifies the type of stick-type substrate 150 at the start of heating, and determines that a first puff timing has been reached, based on the information indicating each of the plurality of first puff timings, which is associated with the type of stick-type substrate 150 identified, and gives notification to the user. By virtue of this feature, the inhalation device 100 alone is capable of determining that a first puff timing has been reached, even if there are multiple types of stick-type substrates 150 that may be used in the inhalation device 100.

### (4) Fourth Variant Example

Although the above embodiment described an example in which the terminal device 200 sets, as the first puff timing, a timing which is the same as the second puff timing, the present disclosure is not limited to such an example. The terminal device 200 may set, as the first puff timing, a timing which is different from the second puff timing. That is to say, the terminal device 200 may set, as the first puff timing, a timing shifted from the second puff timing. As an example, if the user took puffs at an average of 20-second intervals in a plurality of past heating sessions, the terminal device 200 may set the first puff timing at 30-second intervals in the next heating session. As another example, the terminal device 200 may set a time shifted by around 10 seconds before or after the average value of initial second puff timings (i.e., the time elapsed from the start of heating) in a plurality of past heating sessions as the initial first puff timing in the next heating session. By virtue of this feature, smoking taste evaluations obtained from puffs taken at various timings can be collected. As a result, the heating profile can be updated more efficiently.

### (5) Other

Although the embodiments above described an example in which the behavior history of the user includes information indicating the second puff timing, the present disclosure is not limited to such an example. The behavior history of the user may include information indicating a taste evaluation which has been set, in addition to the information indicating the second puff timing. For example, the behavior history of the user may include a combination of the second puff timing and information indicating a smoking taste evaluation which was set in relation to the aerosol inhaled at that second puff timing. The terminal device 200 may then set, as the first puff timing, a timing which is the same as a second puff timing for which a good evaluation was set. By virtue of this feature, the user can take puffs at the same timing as a second puff timing for which a good evaluation was set in the past.

The embodiments above described an example in which a parameter relating to the temperature at which the aerosol source is heated, as defined in the heating profile, is the target temperature of the heating unit 121, but the present disclosure is not limited to such an example. The electrical resistance value of the heating unit 121 may be cited as a parameter relating to the temperature at which the aerosol source is heated, in addition to the actual temperature of the heating unit 121 described in the embodiment above. Furthermore, when the means for heating the aerosol source is induction heating, a target value such as the temperature of a susceptor or the electrical resistance value of an electromagnetic induction source may be cited as a parameter relating to the temperature at which the aerosol source is heated, as defined in the heating profile.

The embodiments above described an example in which the inhalation device 100 generates the aerosol by heating the stick-type substrate 150, but the present disclosure is not limited to such an example. The inhalation device 100 may equally be configured as what is known as a liquid atomization aerosol-generating device, which generates an aerosol by heating and atomizing a liquid aerosol source. The features of the present disclosure may also be applied to a liquid atomization aerosol-generating device.

As described in the embodiments above, it is the terminal device 200 which receives the settings of the first puff timing and the evaluation period, and settings of the smoking taste evaluation in the evaluation period. Here, the terminal device 200 implementing the various types of processing described above may also refer to a native application installed on the terminal device 200 implementing the various types of processing described above. Furthermore, the terminal device 200 implementing the various types of processing described above may also refer to PWA (progressive web apps) provided for the terminal device 200 implementing the various types of processing described above. As an example, a server may implement the various types of processing described above via a PWA provided for the terminal device 200.

It should be noted that the series of processes performed by each device described in the present description may be realized by using software, hardware, and any combination of software and hardware. Programs constituting the software are prestored on a recording medium (more specifically, a non-transitory computer-readable storage medium) provided internally or externally to each device, for example. When the programs are then executed, for example, by a computer for controlling each device described in the present description, the programs are read into a RAM and executed by means of a processing circuit such as a CPU. The recording medium is, for example, a magnetic disk, an optical disk, a magneto-optical disk, or a flash memory, etc. Furthermore, the computer programs may be distributed via a network, for example, without the use of a recording medium. Furthermore, the computer may be an application-specific integrated circuit such as ASIC, a general-purpose processor which executes functions by reading software programs, or a computer on a server used for cloud computing, etc. Furthermore, the series of processes performed by each device described in the present description may be processed in a distributed manner by multiple computers.

Furthermore, the processing described using flowcharts and sequence diagrams in the present description need not necessarily be implemented in the order depicted. Some processing steps may be implemented in parallel. Furthermore, additional processing steps may be employed and some processing steps may be omitted.

It should be noted that the following configurations also fall within the technical scope of the present invention.
(1)

A terminal device comprising:
a control unit for controlling processing wherein an evaluation period, in which a user is able to set a smoking taste evaluation in relation to an aerosol generated by an inhalation device which generates the aerosol by heating an aerosol source contained in a substrate, is set on the basis of a behavior history of the user, and setting of the smoking taste evaluation is received in the evaluation period which has been set.
(2)

The terminal device as disclosed in (1) or (2) above, wherein
the control unit sets a plurality of evaluation periods within a period during which the aerosol is generated by heating one substrate, and
the behavior history of the user includes intervals of a plurality of second puff timings, which are timings at which the user actually inhaled the aerosol within a past period in which the aerosol was generated by heating one substrate.
(3)

The terminal device as disclosed in (1) or (2) above, wherein
the control unit sets a plurality of evaluation periods within a period during which the aerosol is generated by heating one substrate, and
the behavior history of the user includes each of a plurality of second puff timings, which are timings at which the user actually inhaled the aerosol within a past period in which the aerosol was generated by heating one substrate.
(4)

The terminal device as disclosed in any one of (1) to (3) above, wherein
the control unit also sets the evaluation period on the basis of the behavior history of another user.
(5)

The terminal device as disclosed in any one of (1) to (4) above, wherein
the control unit controls processing to notify the user of information indicating the evaluation period.
(6)

The terminal device as disclosed in any one of (1) to (5) above, wherein
the inhalation device heats the aerosol source on the basis of control information defining a parameter relating to a temperature at which the aerosol source is heated, and
the control unit sets the evaluation period on the basis of the control information used by the inhalation device.
(7)

The terminal device as disclosed in any one of (1) to (6) above, wherein
the control unit sets the evaluation period on the basis of the substrate used in the inhalation device.
(8)

The terminal device as disclosed in any one of (1) to (7) above, wherein
the control unit terminates acceptance of setting of the smoking taste evaluation in the evaluation period when the smoking taste evaluation has been set or when the evaluation period has expired.
(9)

The terminal device as disclosed in any one of (1) to (8) above, wherein
the control unit controls processing to notify the user of the smoking taste evaluation which has been set.
(10)

The terminal device as disclosed in any one of (1) to (9) above, wherein
the control unit sets a first puff timing on the basis of the behavior history of the user, the first puff timing being a timing at which the user should inhale the aerosol generated by the inhalation device, and the control unit sets the evaluation period on the basis of the first puff timing which has been set.
(11)

The terminal device as disclosed in (10) above, wherein
the behavior history of the user includes information indicating a second puff timing, which is a timing at which the user actually inhaled the aerosol within a past period in which the aerosol was generated by heating one substrate, and
the control unit sets, as the first puff timing, a timing which is the same as the second puff timing.
(12)

The terminal device as disclosed in (10) above, wherein
the behavior history of the user includes information indicating a second puff timing, which is a timing at which the user actually inhaled the aerosol within a past period in which the aerosol was generated by heating one substrate, and
the control unit sets, as the first puff timing, a timing which is different from the second puff timing.
(13)

A control method implemented by means of a computer, the control method comprising:
controlling processing wherein an evaluation period, in which a user is able to set a smoking taste evaluation in relation to an aerosol generated by an inhalation device which generates the aerosol by heating an aerosol source contained in a substrate, is set on the basis of a behavior history of the user, and setting of the smoking taste evaluation is received in the evaluation period which has been set.

### REFERENCE SIGNS LIST

1 System
100 Inhalation device
111 Power source unit
112 Sensor unit
113 Notification unit
114 Memory unit
115 Communication unit
116 Control unit
121 Heating unit
140 Accommodating portion
141 Internal space
142 Opening
143 Bottom portion
144 Heat insulating portion
150 Stick-type substrate
151 Substrate portion
152 Mouthpiece portion
200 Terminal device
210 Input unit
220 Output unit
230 Detection unit
240 Communication unit
250 Memory unit
260 Control unit

1-13. (canceled)

14. A terminal device comprising:
circuitry configured to:
set, based on a behavior history of a user, an evaluation period in which the user is able to set an evaluation of a smoking taste of an aerosol generated by an inhalation device that heats an aerosol source contained in a substrate to generate the aerosol, and
accept setting of the evaluation of the smoking taste during the set evaluation period.

15. The terminal device of claim 14, wherein
the circuitry is configured to set, based on the behavior history of the user, a first puff timing at which the user should inhale the aerosol generated by the inhalation device, and
the circuitry is configured to set the evaluation period based on the set first puff timing.

16. The terminal device of claim 15, wherein
the circuitry is configured to set a plurality of first puff timings and a plurality of evaluation periods within a period during which the aerosol is generated by heating one substrate, and
the behavior history of the user includes intervals between a plurality of second puff timings, the second puff timings being timings at which the user actually inhaled the aerosol within a past period during which the aerosol was generated by heating one substrate.

17. The terminal device of claim 15, wherein
the circuitry is configured to set a plurality of first puff timings and a plurality of evaluation periods within a period during which the aerosol is generated by heating one substrate, and
the behavior history of the user includes each of a plurality of second puff timings, the second puff timings being timings at which the user actually inhaled the aerosol within a past period during which the aerosol was generated by heating one substrate.

18. The terminal device of claim 15, wherein
the behavior history of the user includes information indicating a second puff timing at which the user actually inhaled the aerosol within a past period during which the aerosol was generated by heating one substrate, and
the circuitry is configured to set, as the first puff timing, a timing that is the same as the second puff timing.

19. The terminal device of claim 15, wherein
the behavior history of the user includes information indicating a second puff timing at which the user actually inhaled the aerosol within a past period during which the aerosol was generated by heating one substrate, and
the circuitry is configured to set, as the first puff timing, a timing that is different from the second puff timing.

20. The terminal device of claim 14, wherein
the circuitry is configured to set the evaluation period further based on a behavior history of another user.

21. The terminal device of claim 14, wherein
the circuitry is configured to control notification to the user of information indicating the evaluation period.

22. The terminal device of claim 14, wherein
the inhalation device heats the aerosol source based on control information defining a parameter relating to a temperature at which the aerosol source is heated, and
the circuitry is configured to set the evaluation period based on the control information used by the inhalation device.

23. The terminal device of claim 14, wherein
the circuitry is configured to set the evaluation period based on the substrate used in the inhalation device.

24. The terminal device of claim 14, wherein
the circuitry is configured to terminate acceptance of setting of the evaluation of the smoking taste in the evaluation period when the evaluation of the smoking taste has been set or when the evaluation period has expired.

25. The terminal device of claim 14, wherein
the circuitry is configured to control notification to the user of the evaluation of the smoking taste that has been set.

26. The terminal device of claim 15, wherein
the circuitry is configured to control the inhalation device to notify the user of information indicating the first puff timing.

27. The terminal device of claim 15, wherein
the circuitry is configured to set, as the evaluation period, a period of predetermined duration starting from the first puff timing.

28. The terminal device of claim 14, further comprising:
a touch panel display,
wherein the circuitry is configured to:
control the touch panel display to display a user interface screen during the evaluation period, and
accept, via the touch panel display, the setting of the evaluation of the smoking taste during the evaluation period.

29. The terminal device of claim 28, wherein
the evaluation of the smoking taste comprises an evaluation of at least one of a smoking feel, an amount of smoke, and a liking for a flavor of the aerosol.

30. The terminal device of claim 15, further comprising:
a communication interface configured to communicate with the inhalation device,
wherein the circuitry is configured to:
determine that the first puff timing has been reached based on a time elapsed from a start of heating by the inhalation device, and
transmit, via the communication interface, information indicating that the first puff timing has been reached to the inhalation device.

31. The terminal device of claim 14, further comprising:
a memory configured to store the behavior history of the user,
wherein the circuitry is configured to retrieve the behavior history from the memory.

32. A terminal device comprising:
a touch panel display;
a communication interface configured to communicate with an inhalation device that heats an aerosol source contained in a substrate to generate an aerosol; and
circuitry configured to:
set, based on a behavior history of a user, a plurality of first puff timings at which the user should inhale the aerosol generated by the inhalation device within a period during which the aerosol is generated by heating one substrate,
determine that each first puff timing has been reached based on a time elapsed from a start of heating by the inhalation device,
transmit, via the communication interface, information indicating that the first puff timing has been reached to the inhalation device,
set, based on each first puff timing, an evaluation period in which the user is able to set an evaluation of a smoking taste of the aerosol inhaled at the first puff timing,
control the touch panel display to display a user interface screen for setting the evaluation of the smoking taste during the evaluation period, and
accept, via the touch panel display, the setting of the evaluation of the smoking taste during the evaluation period.

33. A control method executed by circuitry of a terminal device, the method comprising:
setting, by the circuitry, based on a behavior history of a user, an evaluation period in which the user is able to set an evaluation of a smoking taste of an aerosol generated by an inhalation device that heats an aerosol source contained in a substrate to generate the aerosol; and
accepting, by the circuitry, setting of the evaluation of the smoking taste during the set evaluation period.
